(19) United States
(12) Patent Application Publication
(10) Pub. No.: US 2005/0093837 A1
(43) Pub. Date: May 5, 2005

(54) Electronic pen-like input device

(76) Inventor: Yuval Singer, Haifa (IL)

Correspondence Address: Angenehm Law Firm, Ltd., P.O. Box 48755, Coon Rapids, MN, 55448-0755, US

(21) Appl. No.: 10/960,797

(22) Filed: Oct. 7, 2004

(30) Foreign Application Priority Data
Oct. 7, 2002 (WO) PCT/IL02/00284

(51) Int. Cl. G09G 5/00

(52) U.S. Cl. 345/179

(57) ABSTRACT

An electronic pen-like device 1 including a handheld barrel 3 with a stylus member 4 slidingly reciprocatable between an outwardly biased projecting position and a fully retracted position relative to the barrel on being depressed against a surface; a movement tracking apparatus 16 for tracking sideways movement of the stylus member across tge surface when depressed thereagainst to a partially retracted position between the extreme positions; and a sensor 28 for sending the arrival of the stylus member at the fully retracted position.

### FIELD OF THE INVENTION

The invention is in the field of electronic pen-like input devices for enabling user interfacing with an electronic apparatus.

### BACKGROUND OF THE INVENTION

Electronic apparatus for user interfacing with one or more user interactive applications include inter alia PCs including desktop computers, laptop computers, notebook computers, and the like; handheld PDAs including so-called smartphones combining the functionalities of a PDA and a mobile telephone; interactive television; amongst others. Exemplary electronic pen-like input devices for user interfacing with user interactive applications are illustrated and described in inter alia: U.S. Pat. No. 5,291,213 to Krauss, U.S. Pat. No. 5,459,489 to Redford, U.S. Pat. No. 6,104,388 to Nagai et al, WO98/10604 to Shapira, amongst others.

### SUMMARY OF THE INVENTION

In accordance with the present invention, there is provided an electronic pen-like input device comprising a handheld barrel with a stylus member slidingly reciprocatable between an outwardly biased projecting position relative to said barrel and a fully retracted position relative to said barrel on being depressed against a surface; movement tracking apparatus for tracking sideways movement of said stylus member across the surface when depressed thereagainst to a partially retracted position between said extreme positions; and a sensor for sensing the arrival of said stylus member at said fully retracted position.

The input device of the present invention enables user interfacing with a wide range of user interactive applications by natural hand movements including line tracing movements between two points, handwriting movements, and so-called “clicks” associated with mouse buttons of a conventional computer mouse. The input device of the present invention is capable of sensing these movements when its stylus member is being drawn across surfaces of varying firmness ranging from a relatively soft surface, say, a user's trouser when it is being used for user interfacing with interactive television to a relatively hard surface, say, a desktop when it is being used for user interfacing with an interactive user application running on a desktop computer. Moreover, the input device is capable of sensing these movements when it itself is disposed at a wide range of orientations relative to the horizontal. Thus, the electronic pen-like input device of the present invention lends itself to be readily implementable for use with different host electronic apparatus including inter alia a PC, interactive television, a PDA, and the like. The host electronic apparatus may also include handwriting recognition software, for example, PenReader™ commercially available from Paragon Software.

### BRIEF DESCRIPTION OF THE DRAWINGS

In order to understand the invention and to see how it can be carried out in practice, a preferred embodiment will now be described, by way of a non-limiting example only, with reference to the accompanying drawings, in which similar parts are likewise numbered, and in which:

FIG. 1 is a pictorial representation of an electronic pen-like input device for user interfacing with a desktop PC;

FIG. 2 is a longitudinal cross section view of the input device along the line A-A in FIG. 1;

FIG. 3 is a perspective close-up view of the movement tracking apparatus for tracking sideways movement of the input device across a surface;

FIG. 4 is an exploded view of the stylus holder and the stylus member of the input device;

FIG. 5A is a longitudinal cross sectional close-up view of the input device showing its stylus member in its outwardly biased projecting position; and

FIG. 5B is a longitudinal cross sectional close-up view of the input device showing its stylus member in its fully retracted position.

### DETAILED DESCRIPTION OF THE DRAWINGS

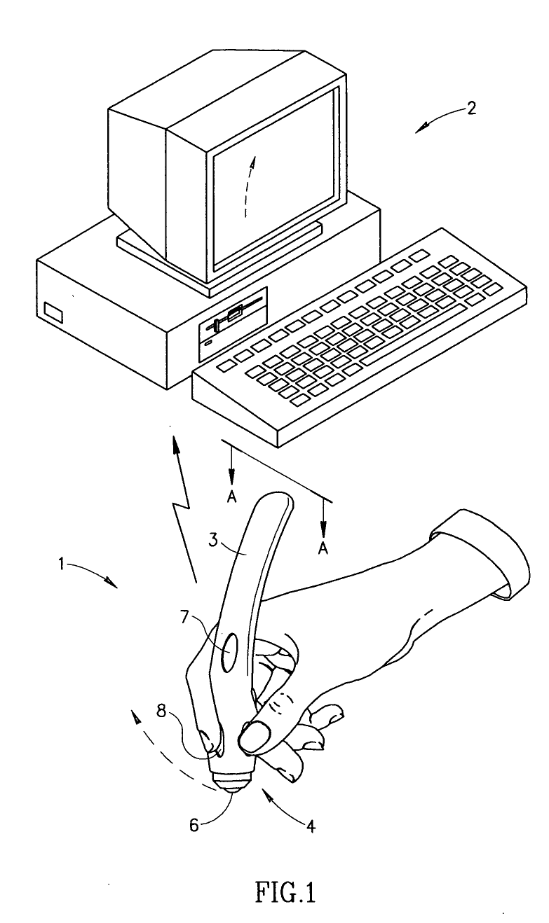

FIG. 1 shows an electronic pen-like input device 1 for enabling user interfacing with interactive user applications, for example, Windows desktop, Microsoft Word, Microsoft Outlook, Microsoft Internet Explorer, and the like, on a desktop PC 2. The input device 1 includes a handheld open-ended barrel 3 terminating in a stylus member 4 with a ball 6 for being rolled across a surface. The barrel 1 is formed with an IR transparent window 7 for enabling IR communication with the PC 2. The input device 1 includes a pushbutton 8 directly beneath the IR transparent window 7 for selective depression by a user's forefinger when holding the input device 1. Depression of the pushbutton 8 corresponds to a click on the right mouse button of a conventional computer mouse. The IR transparent window 7 and the pushbutton 8 are the front of the input device 1 corresponding to the front of a conventional computer mouse. The input device 1 is normally powered off and is automatically powered on when the ball 6 is rolled across a surface.

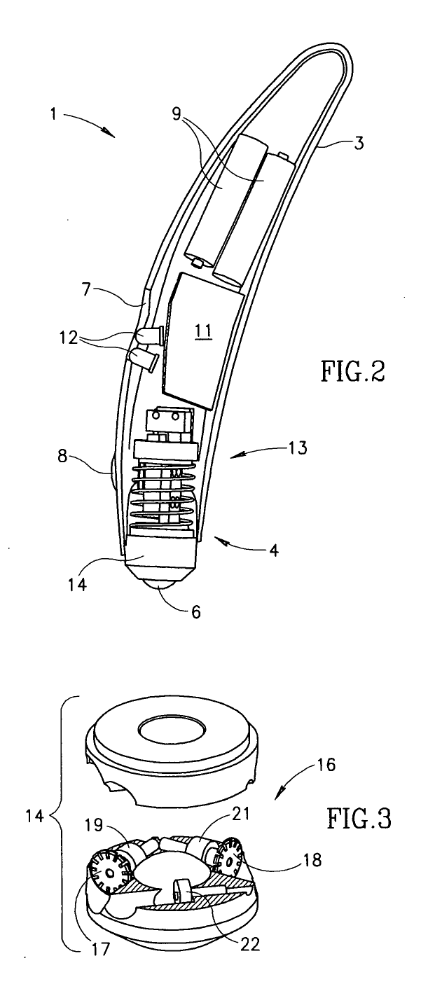

FIG. 2 shows that the barrel 3 accommodates two batteries 9, electronic circuitry 11, a pair of IR transmitters 12 for wireless communication through the IR transparent window 7 with the PC 2, and a stylus holder 13 in operative association with the stylus member 4. The stylus member 4 has a cylindrical body 14 containing movement tracking apparatus 16 for tracking the rolling movement of the ball 6 as it is rolled across a surface (see FIG. 3). FIG. 3 shows that the movement tracking apparatus 16 is similar to that employed in a conventional computer mouse insofar that it employs a pair of optical encoders (not shown) having slotted encoder discs 17 and 18 respectively driven by rollers 19 and 21 contacting the ball 6, and a roller 22 equidistanced between the points of contacts of the rollers 19 and 21 with the ball 6. Also, the rollers 19 and 21 are orthogonally disposed one to the other in a top view of the ball (not shown) for respectively providing x and y components of the input device's sideways movement across a surface.

But the movement tracking apparatus 16 differs from the movement tracking apparatus of a conventional computer mouse both in terms of the material from which its components are made and their arrangement to enable the input device 1 to be used at various dispositions relative to the horizontal and on various surfaces whilst still enabling accurate tracking of the input device's sideways movements across a surface requiring, on the one hand, the ball's free rolling movement at all times and, on the other hand, accurate proportional transfer of the ball's rolling movement to the rollers 19 and 21 in accordance with the direction of the input device's sideways movement across a surface. This is achieved by the rollers 19, 21 and 22 being made from stainless steel and being highly smooth, and the ball 6 being made from nylon or Teflon™, and having a Shore-A hardness of at least 90, and the rollers 19, 21 and 22 contacting the upper hemisphere of the ball 6 with respect to its point of contact with a surface at about the 35° parallel of latitude. Also, radial play ball bearings, for example, commercially available from Sterling, USA, rigidly mounted on the lower half of the cylindrical body 14 rotatably support the rollers 19, 21 and 22.

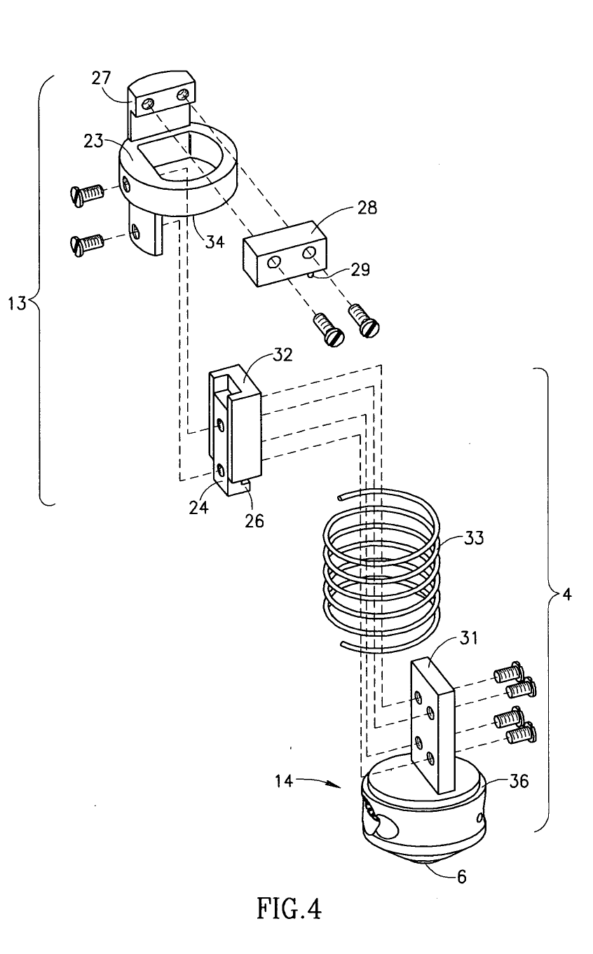

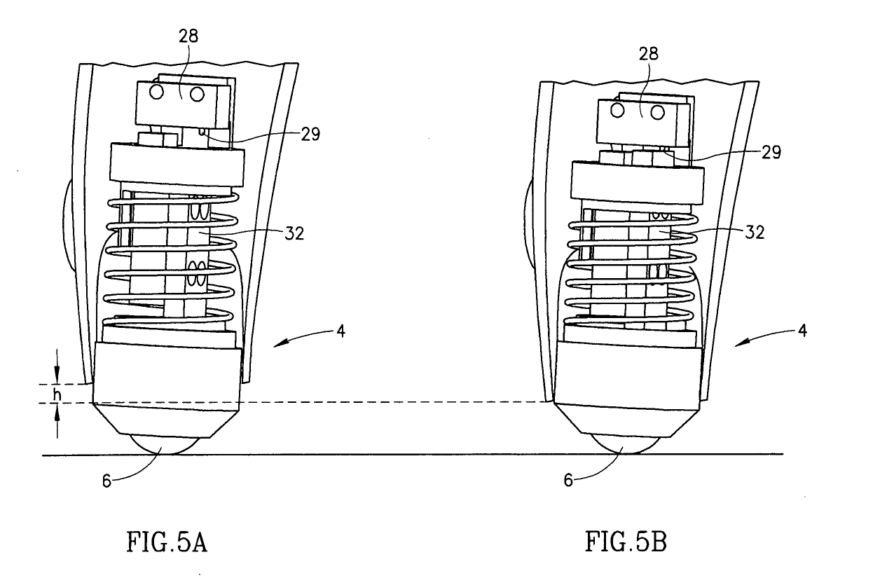

FIG. 4 shows that the stylus holder 13 includes an annular member 23 rigidly affixed to the barrel 3. The annular member 23 is formed with a downwardly depending slide member 24 terminating at its lowermost end at a stopper 26, and an upwardly disposed support member 27 for supporting a sensor 28 having a contact 29. The stylus member 4 is formed with an upright flange 31 rigidly attached thereto to which is also rigidly attached a grooved slide member 32 for sliding reciprocation between two extreme positions, namely, a fully projecting position (see FIG. 5A) on its abutment against the stopper 26 and a fully retracted position (see FIG. 5B) on its abutment against the sensor 28 on depression of the stylus member 4 against a surface. A compression spring 33 is interdisposed between a leading surface 34 of the annular member 23 and a trailing surface 36 of the cylindrical body 16 for outwardly biasing the stylus member 4 relative to the barrel 3 into its fully projecting position. Arrival of the slide member 32 at the sensor 28 corresponds to a click on the left mouse button of a conventional computer mouse. The stroke h of the stylus member 4 between its outwardly biased projecting position and its fully retracted position is about 4 mm and typically within the range of 4±0.5 mm whilst the force of the compression spring 33 is about 50 gram such that the stylus member 4 is typically depressed into a partially retracted position between its two extreme positions on holding the input device 1 largely upright such that its ball 6 contacts a surface.

The operation of the electronic pen-like input device 1 is now described:

A user grips the input device as he would grip a pen in such a manner that he can lightly rest his forefinger on the finger depressible control. The user uses the input device in an analogous fashion to a conventional computer mouse having a ball, a left mouse button, and a right mouse button as follows: First, the user lightly depresses the stylus member against a surface and rolls the ball thereacross for cursor control. Second, the user fully depresses the input device against a surface and rolls the ball thereacross for left click operations, for example, dragging and dropping of objects. Third, the user fully depresses the input device against a surface twice in rapid succession for effecting double left click operations. And finally, the user clicks on the pushbutton for effecting right click operations.

While the invention has been described with respect to a limited number of embodiments, it will be appreciated that many variations, modifications, and other applications of the invention can be made within the scope of the appended claims. For example, the electronic pen-like input device of the present invention may employ an optical mechanism for directly tracking movement on a surface in a similar manner to Microsoft's IntelliMouse®. Also, the electronic pen-like input device of the present invention can communicate with a host electronic apparatus over a wireline connection whilst wireless communication can be achieved by other conventional wireless means, for example, RF, Bluetooth, and the like.

1. An electronic pen-like input device comprising a handheld barrel with a stylus member slidingly reciprocatable between an outwardly biased projecting position relative to said barrel and a fully retracted position relative to said barrel on being depressed against a surface; a movement tracking apparatus for tracking sideways movement of said stylus member across the surface when depressed thereagainst to a partially retracted position between said extreme positions; and a sensor for sensing the arrival of said stylus member at said fully retracted position.

2. The device according to claim 1 wherein said movement tracking apparatus tracks sideways movement of said stylus member across the surface when depressed to said fully retracted position.

3. The device according to claim 1 wherein two movements of the input device against the surface to said fully retracted position of said stylus member in rapid succession correspond to a double click on the left mouse button of a conventional computer mouse.

4. The device according to claim 3 and further comprising a finger depressible button disposed on the exterior of said barrel towards a tip, and whose depression corresponds to a click on the right mouse button of a conventional computer mouse.

5. The device according to claim 1 wherein said stylus member includes a ball for rolling on the surface and said movement tracking apparatus includes at least two encoders each having a roller contacting a mid parallel of latitude of an upper hemisphere of said ball with respect to its point of contact with the surface for providing x and y coordinates resultant from the rolling of said ball on the surface.

6. The device according to claim 5 wherein said rollers are formed from stainless steel and are highly smooth, and at least one of said ball has a Shore-A hardness of at least about 90.

7. The device according to claim 5 wherein radial play ball bearings rotatably support said rollers.

8. The device according to claim 7 wherein said radial play ball bearings are rigidly supported on said stylus member.

9. The device according to claim 1 wherein the input device employs an optical mechanism for directly tracking sideways movement of said stylus member across the surface.

10. The device according to claim 1 wherein said stylus member slidingly reciprocates between said extreme positions through a stroke of about 4 mm.

11. The device according to claim 1 wherein the device is normally powered off and automatically powered on as said stylus member is drawn across the surface.

12. The device according to claim 1 wherein the input device is in wireless communication with a host electronic apparatus.
